(19) United States
(12) Patent Application Publication
(10) Pub. No.: US 2009/0149189 A1
(43) Pub. Date: Jun. 11, 2009

(54) METHOD AND APPARATUS FOR SUPPORTING CONFIGURATION AND CONTROL OF THE RLC AND PDCP SUB-LAYERS

(75) Inventors: Mohammed Sammour, Montreal (CA); Shankar Somasundaram, Deer Park, NY (US); Rajat P. Mukherjee, Stanford, CA (US); Stephen E. Terry, Northport, NY (US); Arty Chandra, Manhasset Hills, NY (US); Jin Wang, Central Islip, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/328,921

(22) Filed: Dec. 5, 2008

Related U.S. Application Data
(60) Provisional application No. 61/012,096, filed on Dec. 7, 2007.
(60) Provisional application No. 61/012,278, filed on Dec. 7, 2007.

(51) Int. Cl. H04W 72/00

(52) U.S. Cl. 455/450

(57) ABSTRACT

Methods and apparatus support configuration and/or control of the radio link control (RLC) and packet data convergence protocol (PDCP) sub-layers by defining and utilizing radio resource control (RRC) parameters and procedures, and by including information elements (IEs) in RRC messages in both the uplink and downlink for RLC and PDCP configuration.

### CROSS REFERENCE TO RELATED APPLICATIONS

This application claims the benefit of U.S. Provisional Application No. 61/012,096, filed Dec. 7, 2007, and of U.S. Provisional Application No. 61/012,278, filed Dec. 7, 2007, which are incorporated by reference as if fully set forth.

### FIELD OF INVENTION

This application is related to wireless communications.

### BACKGROUND

Wireless communication systems are well known in the art. Communications standards are developed in order to provide global connectivity for wireless systems and to achieve performance goals in terms of, for example, throughput, latency and coverage. One current standard in widespread use, called Universal Mobile Telecommunications Systems (UMTS), was developed as part of Third Generation (3G) Radio Systems, and is maintained by the Third Generation Partnership Project (3GPP).

FIG. 1 shows an overview of a system architecture of a conventional UMTS network 100, which includes a UMTS Terrestrial Radio Access Network (UTRAN), 101. The UTRAN, 101, has one or more radio network controllers (RNCs) 104 and base stations 102, referred to as Node Bs or evolved Node Bs (eNode Bs) by 3GPP, which collectively provide for the geographic coverage for wireless communications with a wireless transmit/receive units (WTRUs) 105, referred to as user equipments (UEs) by 3GPP. The geographic coverage area of a Node B 102 is referred to as a cell. The UTRAN is connected to a core network (CN) 103.

An objective of the Evolved Universal Mobile Telecommunications System (UMTS) Terrestrial Radio Access (E-UTRA) program and the UMTS Terrestrial Radio Access Network (UTRAN) program of the 3GPP is to develop a packet-optimized radio access network with high data rates, low-latency, and improved system capacity and coverage. To achieve these goals, an evolution of the radio interface as well as the radio network architecture should be considered. For example, instead of using code division multiple access (CDMA) currently used in 3GPP, Orthogonal Frequency Division Multiple Access (OFDMA) and FDMA are proposed air interface technologies to be used in the downlink and uplink transmissions, respectively. Another proposed change is to apply an all packet switched service in the long term evolution (LTE) project. This means voice calls will be made on a packet switched basis.

FIG. 2 shows a wireless communication system 200 including a wireless transmit/receive unit (WTRU) 201 and an evolved Node B (eNB) 202 including a conventional LTE user-plane protocol stack. In each of the WTRU 201 and the base station 202 is a 3GPP LTE user-plane protocol stack architecture that includes several layers/entities. The WTRU 201 includes a radio resource control layer/entity(s) (RRC) 203A, a packet data convergence protocol (PDCP) layer/entity(s) 204A, a radio link control (RLC) layer/entity(s) 205A, a medium access control (MAC) layer/entity(s) 206A and a physical (PHY) layer/entity(s) 207A. The base station 202 includes a RRC layer/entities 203B, a PDCP layer/entity(s) 204B, an RLC layer/entity(s) 205B, a MAC layer/entity(s) 206B and a physical layer/entity(s) 207B. The PDCP 204A/B, RLC 205A/B and MAC 206A/B may also be referred to as sublayers of layer 2 (L2), whereas the PHY layer 207A/B may also be referred to as layer 1 (L1).

The RRC sublayer 203A/B, part of layer 3, handles the control signaling of layer 3 between the WTRU and the eNB. It makes handover decisions based on measurement reports from the WTRU and executes transmission of the WTRU context from the source eNB to the target eNB during the handover. The RRC sublayer 203A/B is also responsible for setting up and maintaining radio bearers. The RRC protocol includes the following functions. The RRC protocol handles broadcast of system information including access stratum (AS) and non-access stratum (NAS), paging, and RRC connection control including assignment and/or modification of temporary WTRU cell radio network temporary identifier (C-RNTI), and establishment, modification and/or release of system radio blocks (SRB) SRB1 and SRB2. The RRC protocol also handles RRC connection mobility (handover) including intra-frequency, inter-frequency and inter-radio access technology (RAT) selection, and specification of RRC context information transferred between network nodes. The RRC protocol also handles cell selection and reselection control including neighboring cell information, indication of cell selection and re-selection parameters, and intra-frequency, inter-frequency and inter-RAT selection.

The RRC protocol also handles measurement configuration control and reporting including establishment, modification and/or release of measurements (e.g. intra-frequency, inter-frequency and inter-RAT mobility, quality, WTRU internal, and positioning), configuration and activation and de-activation of measurement gaps and measurement reports. The RRC protocol also handles security management including configuration of AS integrity protection (CP) and AS ciphering (CP, UP), and radio configuration control including establishment, modification and release of user plane radio bearers (RBs) including Automatic Repeat Request (ARQ) configuration, and assignment and modification of hybrid ARQ (HARQ) and discontinuous reception (DRX) configurations. The RRC protocol also handles QoS control including configuration of semi-persistent allocations for initial HARQ transmissions in the downlink, covering a limited set of possible resources that are blindly decoded by the WTRU, and assignment and/or modification of parameters for uplink rate control in the UE such as allocation of a priority and a prioritized bit rate (PBR) for each RB. The RRC protocol handles transfer of dedicated NAS information and multicast and broadcast including notification of service and session start, indication of available services, establishment and/or modification release of RBs. The RRC protocol also handles the indication of access restrictions, recovery from out of service, WTRU capability transfer, support for E-UTRAN sharing and generic protocol error handling.

The Long Term Evolution (LTE) project architecture Layer 2 user-plane protocol, is divided into three sublayers: Medium Access Control (MAC), Radio Link Control (RLC) and Packet Data Control Protocol (PDCP). While the transport channels describe how and what data is transferred, the logical channels between the MAC and RLC sublayers describe what is transferred. Each logical channel type is defined by what kind of information is transferred. The logical channels are divided in two groups which are control channels and traffic channels. The control channels are used for transfer of control plane information, and the traffic channels are used for transfer of user plane information.

The PDCP sublayer performs robust header compression (ROHC) to improve transmission for latency sensitive data such as voice over IP (VoIP) and video telephony. It also has ciphering abilities for security. The PDCP sublayer provides the following main services and functions. The PDCP sublayer provides header compression and decompression of internet protocol (IP) data flows using the ROHC protocol, at the transmitting and receiving entity, respectively, and transfer of data including user plane or control plane data. The PDCP sublayer provides maintenance of PDCP sequence numbers for radio bearers mapped on RLC acknowledged mode, in-sequence delivery of upper layer PDUs at handover, and duplicate elimination of lower layer SDUs at handover for radio bearers mapped on RLC acknowledged mode. The PDCP sublayer also provides ciphering and deciphering of user plane data and control plane data, integrity protection of control plane data, and timer based discard.

The RLC sublayer supports three types of data transmission modes: Acknowledge Mode (AM), Unacknowledged Mode (UM) and Transparent Mode (TM). For AM, automated retransmit request (ARQ) is used for retransmissions. ARQ can also be used for status report signaling and for resetting the transmitting and receiving RLC entities. The RLC sublayer also supports segmentation and concatenation of RLC system data units (SDUs). When an RLC packet data unit (PDU) does not fit entirely into a MAC SDU, the RLC SDU will be segmented into variable sized RLC PDUs, which do not include any padding. Re-segmentation of PDUs can be performed when a re-transmitted PDU does not fit into a MAC SDU. The number of re-segmentations is unlimited. SDUs and segments of SDUs are concatenated into PDUs.

The RLC sublayer provides the following main services and functions. The RLC provides transfer of upper layer PDUs supporting AM, UM and TM data transfer. The RLC provides in-sequence delivery of upper layer PDUs except at handover in the uplink (UL), error correction through ARQ, and duplicate detection. The RLC also provides segmentation for dynamic PDU size according to the size of the transport block (TB) without including the padding, and re-segmentation of PDUs that need to be retransmitted. The RLC also provides concatenation of SDUs for the same radio bearer, protocol error detection and recovery, flow control between an eNB and wireless transmit receive unit (WTRU), SDU discard and reset.

The RRC sublayer provides PDCP and RLC configuration parameters for the SRB and data radio blocks (DRBs) as part of the radio resource configuration for configuration of the PDCP and RLC in the receiving entity (WTRU or eNB) by the transmitting entity (eNB or WTRU). A conventional radio resource configuration including PDCP and RLC configuration parameters is shown in Table 1.

TABLE 1
Radio Resource Configuration
Radio Resource Configuration
Parameters

```
SRB list
  Parameters for each SRB
    PDCP configuration, for SRBs
    RLC configuration
    RB mapping information
SAE bearer list
  Parameters for each SAE bearer
    Parameters for each Data Radio
Bearer (DRB)
      PDCP configuration, for DRBs
      RLC configuration
      RB mapping information
Transport channel configuration
Physical channel configuration
```

In evolved UMTS systems including LTE systems, there is need to define and configure new and existing RLC and PDCP parameters and their granularities, and/or the procedures and messages that will carry those parameters so that the communication devices in the system, including WTRUs and eNBs, operate properly, and their various functions and sub-layers are controlled and configured properly.

### SUMMARY

Methods and apparatus for supporting configuration and control of the radio link control (RLC) and packet data control protocol (PDCP) sub-layers by defining and using radio resource control (RRC) parameters and procedures are disclosed. The methods and apparatus disclosed may be used in wireless communications systems including, but not limited to, Third Generation Partnership Project (3GPP) long term evolution and enhanced high speed packet access (HSPA) wireless communications systems. Also disclosed are parameters, procedures and messages for configuring and/or controlling proposed functions of the RLC and PDCP sub-layers.

### BRIEF DESCRIPTION OF THE DRAWINGS

A more detailed understanding may be had from the following description, given by way of example and to be understood in conjunction with the accompanying drawings wherein:

FIG. 1 shows an overview of a system architecture of a conventional UMTS network;

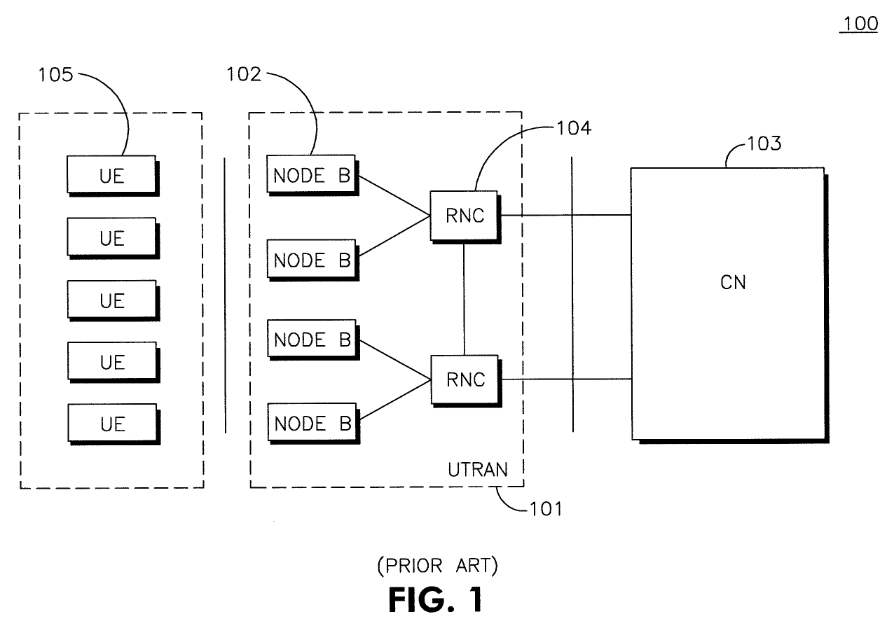

FIG. 2 shows a conventional LTE user-plane protocol stack; and

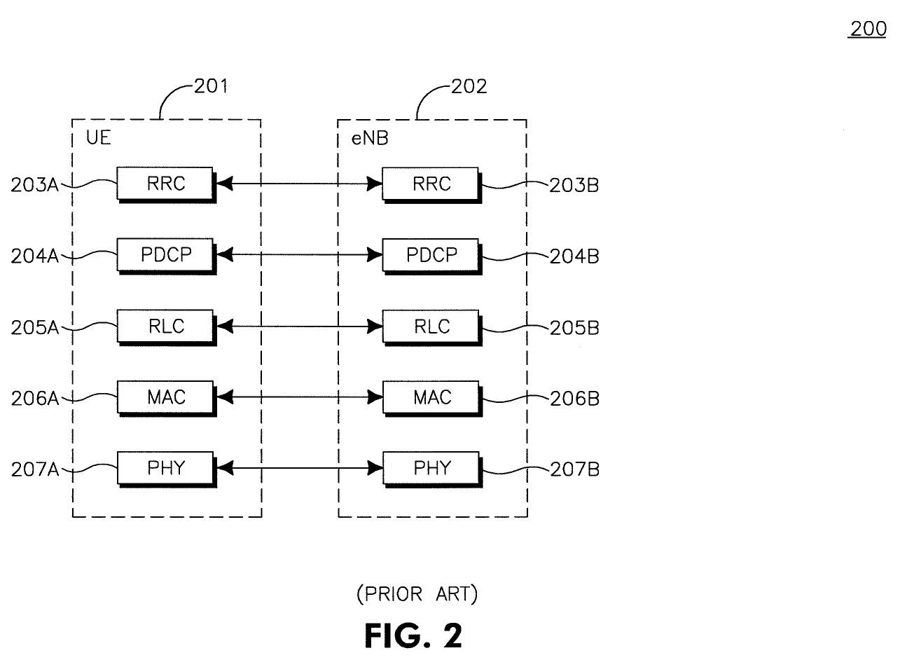

FIG. 3 shows a flow diagram of generating and using information elements (IEs) for configuring PDCP and/or RLC procedures.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

Information elements (IEs) are introduced herein for some of the features and functions of PDCP, and/or certain procedures that will make use of those IEs. Such IEs can either be part of other IEs or can be stand-alone IEs. Some IEs can exist irrespective of whether other IEs exist or not.

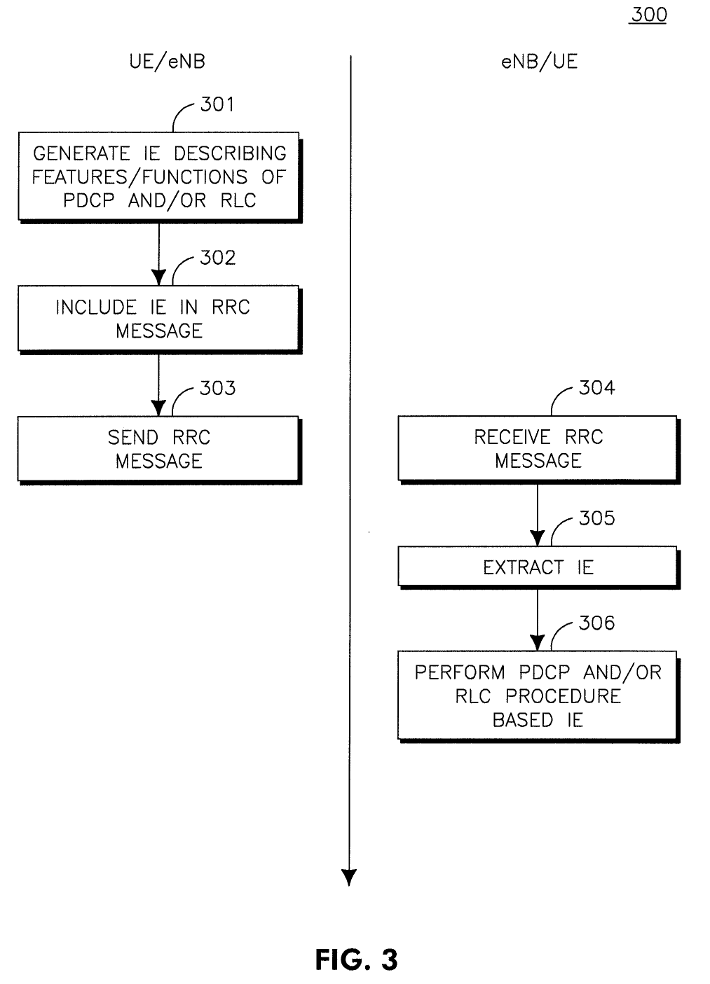

FIG. 3 shows a flow diagram 300, for generating and using IEs for configuring PDCP and/or RLC procedures. IEs may be generated and sent by a WTRU to a eNB, or by a eNB to a WTRU. Steps 301 to 303 are performed by the transmitting device (WTRU or eNB) and steps 304 to 306 are performed by the receiving device (eNB or WTRU). In step 301 an IE describing features and functions of the PDCP layer and/or the RLC layer is generated. In step 302, the IE is included in an RRC message, and in step 303 the RRC layer sends a radio block message to the receiving device (WTRU or eNB). In step 304 the receiving device receives a radio block message containing an IE carrying information about the PDCP or RLC layers of a peer entity. In step 305 the IE is extracted. In step 306, the WTRU procedures and protocols for PDCP and RLC layers are changed based on the RRC IE reconfiguration procedure.

The IEs may be carried in any uplink (UL) or downlink (DL) RRC message. For example, the IEs discussed below may be carried in RRC connection reconfiguration messages, or RRC connection re-establishment messages, or any other RRC messages. Those messages can be exchanged at radio block (RB) setup, or at handover, or a radio link failure event, or any other events. Furthermore, the following IEs may be included as part of a larger IE and may be applied on a per-radio bearer basis. Those messages can be exchanged at RB setup, or at handover, or a radio link failure event, or any other event. The RRC parameters that can be used to configure and control the PDCP layer and/or RLC layer are described in detail below.

RLC and PDCP Reset Indicator IE

The eNB or the WTRU may utilize a RLC or a PDCP reset indicator IE to indicate the need to reset the RRC or the PDCP sub-layer of the peer entity. This IE can be applied on a per-radio bearer basis, as shown in Table 2 below.

TABLE 2

| Name | Semantics description |
|---|---|
| RLC/PDCP reset | TRUE Indicates the RLC/PDCP entity |
| indicator | needs to be reset. |

Upon reception, if the RLC/PDCP reset indicator IE is included (e.g. in an RRC message), the WTRU resets the RLC/PDCP entity. Hence, the RLC/PDCP Reset will be signaled via an RRC procedure/message. In one embodiment, the PDCP entity in the transmitting device (eNB or WTRU) will notify the RRC entity in the same device of the need to reset PDCP. The RRC entity in turn contacts the peer RRC entity in the receiving device (WTRU or eNB) using the appropriate RRC message (e.g. RRC connection reconfiguration, or any other message), and includes in the RRC message the RLC/PDCP reset indicator IE. Upon receiving the RRC message and IE, the peer RRC entity notifies the RLC/PDCP entity of the reset trigger, and RLC/PDCP reset will take place.

RLC Re-Segmentation IE

PDU re-segmentation is a feature of LTE. As shown in Table 3 below a WTRU or eNB may optionally utilize RRC IEs to indicate whether a WTRU supports re-segmentation, or whether a WTRU is allowed to perform re-segmentation based on the network's preference.

Support Re-Segmentation IE

As shown in Table 3, a WTRU or the eNB may use the IE to indicate whether re-segmentation is supported. The IE can be applied on a per-radio bearer basis, or may apply to the whole WTRU or eNB.

TABLE 3

| | Type/ | |
|---|---|---|
| Name | reference | Semantics description |
| RLC Support | Enumerated | TRUE Indicates the RLC entity |
| Re-segmentation | True/false | supports re-segmentation. |

The WTRU may send this IE in an appropriate RRC message. This IE may be part of WTRU capability information elements, such as an RLC Capability IE. As another alternative, two separate IE's may indicate that the RLC supports transmitting re-segmented packets or that the RLC supports receiving re-segmented packets. This allows for an implementation whereby the re-segmentation function is supported in one direction (e.g. the receiving side) but not in the other direction (e.g. the transmitting side).

Allow Re-Segmentation IE

As shown in Table 4, a WTRU or an eNB may use the IE to indicate that the receiving device is allowed to perform and transmit re-segmented RLC PDUs, for example, depending on whether the sender of the IE can receive and process re-segmented PDUs. The IE can be applied on a per-radio bearer basis, or may apply to the whole WTRU or eNB.

TABLE 4

| Name | Type/reference | Semantics description |
|---|---|---|
| RLC Allow Re- | Enumerated | TRUE Indicates the RLC |
| segmentation | True/false | entity is allowed to perform |
| | | re-segmentation. |

Upon reception of the RRC message in the receiving device, if the RLC Allow Re-segmentation IE is included, the WTRU shall configure the RLC entity to allow the transmission of re-segmented packets, that is, enable the re-segmentation function.

HARQ Assistance IEs

As shown in Table 5, the eNB may utilize the IE to indicate to a WTRU that the WTRU RLC sub-layer can retransmit a packet based on HARQ delivery failure indication from the underlying sub-layers. Upon reception of the RRC message, if the Allow HARQ assisted ARQ IE is included, the WTRU may configure the RLC to use the corresponding function according to the value of the IE.

TABLE 5

| Name | Type/reference | Semantics description |
|---|---|---|
| Allow HARQ | Enumerated | TRUE indicates that RLC entity |
| assisted ARQ | True/false | can retransmit PDUs based on |
| | | an indication from lower sub-layers. |

Allow HARQ Assisted RLC Control PDU Retransmission IE

As shown in Table 6 below, the eNB may utilize the IE to indicate to a WTRU that the WTRU RLC sub-layer can retransmit some or all RLC Control PDUs, including for example RLC Status Reports and RLC Reset PDU, based on a HARQ delivery failure indication from the underlying sub-layers. Upon reception, if the Allow HARQ assisted RLC Control PDU Retransmission IE is included, for example, in an RRC message, the WTRU may configure the RLC to use the corresponding function according to the value of the IE.

TABLE 6

| | Type/ | |
|---|---|---|
| Name | reference | Semantics description |
| Allow HARQ assisted | Enumerated | TRUE indicates that RLC |
| RLC Control PDU | True/false | entity can retransmit RLC |
| Retransmission | | Control PDUs based on an |
| | | indication from lower sub-layers. |

RLC/PDCP Sequence Number (SN) Information

The following IEs can be applied on a per-Radio Bearer basis.

SN Length IE for RLC

The eNB may use the IE to indicate to a WTRU which RLC sequence number size it should use, for example, 10-bit or 5-bit SN size. As shown in Table 7A, upon reception, if the SN Length IE is included, for example, in an RRC message, the WTRU can configure the RLC to use the corresponding function according to the value of the IE.

TABLE 7A

| Name | Semantics description |
|---|---|
| SN Length (or SN Size) | Indicates the length of the SN |
| | (e.g. 10 bits or 5 bits) |

To improve robustness, if the SN Length IE is absent, the RLC may optionally be configured to use the higher length SN, for example, 10 bits. As shown in Table 7B, the IEs may be included in other IE's that correspond to uplink and downlink respectively. Alternatively, the two different IE's may be used, one for DL SN Length and the other for UL SN Length. The advantage of this method is that higher efficiency may be achieved on a particular link.

TABLE 7B

| Name | Semantics description |
|---|---|
| DL SN Length (or SN Size) | Indicates the length of the |
| | downlink SN (e.g. 10 bits or 5 bits) |
| UL SN Length (or SN Size) | Indicates the length of the uplink |
| | SN (e.g. 10 bits or 5 bits) |

SN Length IE for PDCP

The eNB may utilize a PDCP SN IE to indicate to the WTRU which PDCP sequence number size it should use, e.g. 12-bit or 7-bit SN, as shown in Table 8A below.

TABLE 8A

| Name | Semantics description |
|---|---|
| SN Length (or SN Size) | Indicates the length of the SN |
| | (e.g. 12 bits or 7 bits) |

Upon reception, if SN length IE is included (e.g. in an RRC message), the WTRU configures PDCP to use the corresponding function according to the value of the IE. To improve robustness, if the SN length IE is absent then the WTRU configures PDCP to use the higher length SN (e.g. 12 bits). Furthermore, for the same RB (e.g. AM RB), the uplink SN can be configured to use a different SN length than the downlink SN of the same RB. In order to achieve that, one can either have the SN Length IE included in other IEs that pertain to uplink and downlink respectively, or one can introduce two different IEs one for DL SN Length and the other for UL SN Length as shown below in Table 8B.

TABLE 8B

| Name | Semantics description |
|---|---|
| DL SN Length (or SN Size) | Indicates the length of the |
| | downlink SN (e.g. 12 bits or 7 bits) |
| UL SN Length (or SN Size) | Indicates the length of the uplink |
| | SN (e.g. 12 bits or 7 bits) |

The advantages of using these parameters include achieving higher efficiency on one link/direction than the other link/direction. For example, if uplink traffic rate is relatively smaller, then it may not need to use the whole 12 bits, but can rather make use of 7 bits, while the downlink direction of the same RB can utilize 12 bits. Furthermore, for a single RB (e.g. AM RB), the uplink SN can be configured to use a different SN length than the downlink SN.

Initial Uplink SN IE for RLC

As shown in Table 9, the eNB may use the IE to indicate to a WTRU the initial RLC sequence number that the WTRU can use for the initial packet to be transmitted by the WTRU.

TABLE 9

| Name | Semantics description |
|---|---|
| DL Starting SN (or | Indicates the initial SN that the UE |
| Initial SN) | should use for its first transmission. |

Upon reception, if the Initial Uplink SN IE is included, for example, in an RRC message, the WTRU may configure the RLC to use the corresponding function according to the value of the IE. To improve robustness, if the Initial Uplink SN IE is absent, the RLC may be configured to use an initial uplink SN of zero. As an alternative, the UL SN Offset IE may be specified to indicate the offset that should be applied to the SN.

Initial Uplink SN IE for PDCP

As shown in Table 9 A, the eNB utilizes a PDCP Initial Uplink SN IE to indicate to the WTRU the initial (starting) PDCP sequence number the WTRU should use for the initial packet to be transmitted by the WTRU.

TABLE 9 A

| Name | Semantics description |
|---|---|
| DL Starting SN (or Initial | Indicates the initial SN that |
| SN) | the WTRU should use for its |
| | first transmission. |

Upon reception, if Initial Uplink SN IE is included (e.g. in an RRC message), the WTRU configures PDCP to use the corresponding function according to the value of the IE. To improve robustness, if the Initial Uplink SN IE is absent, then the WTRU configures PDCP to use an initial uplink SN of zero. As another alternative, UL SN Offset IE may be specified to indicate the offset that should be applied to the SN.

Initial Downlink SN IE for RLC

As shown in Table 10, the eNB may use the IE to indicate to a WTRU the initial RLC sequence number that the eNB can use for the initial packet to be transmitted by the eNB.

TABLE 10

| Name | Semantics description |
|---|---|
| DL Starting SN (or | Indicates the initial SN that the eNB |
| Initial SN) | will use for its first transmission. |

Upon reception, if the Initial Downlink SN IE is included, for example, in an RRC message, the WTRU can configure the RLC to use the corresponding function according to the value of the IE. To improve robustness, if the Initial downlink SN IE is absent, the RLC may be configured to use an initial downlink SN of zero. Alternatively, a DL SN Offset IE may be specified to indicate the offset that should be applied to the SN.

Initial Downlink SN IE for PDCP

As shown in Table 10 A, the eNB utilizes a PDCP Initial Downlink SN IE to indicate to the WTRU the initial (starting) PDCP sequence number the eNB will use for the initial packet to be transmitted by the eNB.

TABLE 10 A

| Name | Semantics description |
|---|---|
| DL Starting SN (or | Indicates the initial SN that the eNB |
| Initial SN) | will use for its first transmission. |

Upon reception, if Initial Downlink SN IE is included (e.g. in an RRC message), the WTRU configures PDCP to use the corresponding function according to the value of the IE. To improve robustness, if the Initial downlink SN IE is absent, then the WTRU configures PDCP to use an initial downlink SN of zero. As another alternative, DL SN Offset IE may be specified to indicate the offset that should be applied to the SN.

RLC SN Info IE

The IE's set forth above that relate to RLC sequence numbers may be amalgamated as part of another IE, such as an RLC SDU Discard Info IE as shown in Table 11. Not all of the IE's in Table 10 need to be present in the aggregated SDU Discard Info IE.

TABLE 11
Name

```
  RLC SN
    SN Length
    UL Initial SN
    DL Initial SN
```

Upon reception, if the SN Info IE is included, for example, in an RRC message, the WTRU may configure the RLC to use the corresponding function according to the value of the IE. If the SN Info IE is absent, the functions used are: configure RLC to use the higher length SN (i.e. 10 bits); configure RLC to use an initial uplink SN of zero; and configure RLC to use an initial downlink SN of zero. The SN Infos IE may be part of another IE such as the RLC configuration IE.

PDCP SN Info IE

Some or all of the above IEs that relate to PDCP sequence number may be amalgamated as part of another IE (i.e. can constitute another IE), such as a PDCP SDU Discard Info IE as the example in Table 11A below shows.

TABLE 11A
Name

```
PDCP SN
  SN Length
  UL Initial SN
  DL Initial SN
```

Not all of the IEs in the table above need to be present in the above aggregated SDU Discard Info IE. Upon reception, if SN Info IE is included (e.g. in an RRC message), the WTRU configures PDCP to use the corresponding function according to the value of the IE. If the SN Info IE is absent, then the WTRU configures PDCP to use the higher length SN (e.g. 12 bits), configures PDCP to use an initial uplink SN of zero, and configures PDCP to use an initial downlink SN of zero. The SN Info IE may be part of another IE such as the PDCP configuration IE for DRBs.

RLC and PDCP Buffer and Window Size IE's

The following IEs can be applied on a per-radio bearer basis. Alternatively, the IEs can be applied to all radio bearers.

WTRU Buffer Size IE for RLC

As shown in Table 12 the WTRU may use the IE to indicate to an eNB the size of the WTRU's RLC buffer, for example, transmit and/or receive buffers, in an appropriate unit such as bytes or number of packets. In one embodiment, it may be specified in terms of the number PDUs.

TABLE 12

| Name | Semantics description |
|---|---|
| UE RLC Buffer Size | Indicates the size of the UE buffer |
| | used for storing RLC packets (e.g. |
| | SDUs) |

The WTRU may send this IE in an appropriate RRC message. This IE may be part of a WTRU capability information element, such as a RLC Capability IE. The eNB can use the WTRU's buffer size information to manage or limit the amount of data it sends to the WTRU, for example, via implementing a window mechanism such as a byte-based windowing mechanism or for any other function. In some variants the RLC Buffer Size may be the total RLC buffer size that is used for storing SDUs and/or PDUs that belong to RB's that utilize AM RLC mode.

WTRU Buffer Size IE for PDCP

As shown in Table 12 A, for supporting a PDCP Buffer Size IE, the WTRU utilizes such an IE to indicate to the eNB (or network in general) the size of the WTRUs PDCP Buffer (e.g. for transmit and/or receive buffers), in any appropriate unit such as bytes or number of packets (e.g. SDUs or PDUs).

TABLE 12 A

| Name | Semantics description |
|---|---|
| WTRU PDCP Buffer | Indicates the size of the WTRU |
| Size | buffer used for storing PDCP |
| | packets (e.g. SDUs) |

The WTRU sends this IE in an appropriate RRC message. This IE may be part of WTRU capability information elements, such as a PDCP Capability IE. The eNB can use the WTRU's buffer size information to manage/limit the amount of data it sends to the WTRU (e.g. via implementing a window mechanism such as a byte-based windowing mechanism for example), or for any other function. Note that in some variants the PDCP Buffer Size may be the total PDCP buffer size that is used for storing SDUs and/or PDUs that belong to RBs that utilize AM RLC mode.

WTRU Window Size IE for RLC

As shown in Table 13, the WTRU may use the IE to indicate to the eNB, or network in general, the size of the WTRU's RLC window, that is, for transmit and/or receive windows, in any appropriate unit such as bytes or number of packets. In one embodiment, it may be specified in terms of the number PDUs.

TABLE 13

| Name | Semantics description |
|---|---|
| UE RLC Window Size | Indicates the size of the UE window |

The WTRU may send the IE in an appropriate RRC message. The IE may be part of WTRU capability information elements, such as a RLC Capability IE. The eNB can use the WTRU's window size information to manage or limit the amount of data it sends to the WTRU, such as via implementing a window mechanism such as a byte-based windowing mechanism, or for any other function.

WTRU Window Size IE for PDCP

As shown in Table 13 A, a PDCP Window Size IE is supported. The WTRU utilizes such an IE to indicate to the eNB (or network in general) the size of the WTRU's PDCP Window (e.g. for transmit and/or receive windows), in any appropriate unit such as bytes or number of packets (e.g. SDUs or PDUs).

TABLE 13 A

| Name | Semantics description |
|---|---|
| WTRU PDCP Window | Indicates the size of the WTRU |
| Size | window |

The WTRU shall send this IE in an appropriate RRC message. This IE may be part of WTRU capability information elements, such as a PDCP Capability IE. The eNB can use the WTRU's window size information to manage/limit the amount of data it sends to the WTRU, by, for example, implementing a window mechanism such as a byte-based windowing mechanism, or for any other function.

eNB Buffer Size IE for RLC

As shown in Table 14, the eNB may use the IE to indicate to the WTRU the size of the eNB's RLC Buffer, specifically the transmit and/or receive buffers that relates to this WTRU, in any appropriate unit such as bytes or number of packets. In one embodiment, it may be specified in terms of the number PDUs.

TABLE 14

| Name | Semantics description |
|---|---|
| eNB Buffer Size | Indicates the size of the eNB buffer |
| | used for storing RLC packets (e.g. |
| | SDUs) |

Upon reception, if the eNB Buffer Size IE is included, for example, in an RRC message, the WTRU can configure the RLC to use the corresponding function according to the value of the IE. The WTRU can use the eNB's buffer size information to manage or limit the amount of data it sends to the eNB, such as via implementing a window mechanism such as a byte-based windowing mechanism, or for any other function.

eNB Buffer Size IE for PDCP

As shown in Table 14 A below, the eNB utilize a PDCP Buffer Size IE to indicate to the WTRU the size of the eNB's PDCP Buffer (e.g. for transmit and/or receive buffers) that relates to this WTRU, in any appropriate unit such as bytes or number of packets (e.g. SDUs or PDUs).

TABLE 14 A

| Name | Semantics description |
|---|---|
| eNB Buffer Size | Indicates the size of the eNB buffer used for |
| | storing PDCP packets (e.g. SDUs) |

Upon reception, if eNB Buffer Size IE is included (e.g. in an RRC message), the WTRU configures PDCP to use the corresponding function according to the value of the IE. The WTRU can use the eNB's buffer size information to manage/limit the amount of data it sends to the eNB (e.g. via implementing a window mechanism such as a byte-based windowing mechanism for example), or for any other function.

eNB Window Size IE for RLC

Table 15 shows an RLC Window Size IE in accordance with one of the proposed embodiments. The eNB may use the IE to indicate to the WTRU the size of the eNB's RLC Window, for example, for transmit and/or receive windows that relate to this WTRU, in any appropriate unit such as bytes or number of packets. In one embodiment, it may be specified in terms of the number PDUs.

TABLE 15

| Name | Semantics description |
|---|---|
| eNB Window Size | Indicates the size of the eNB window |

Upon reception, if the eNB Window Size IE is included, for example, in an RRC message, the WTRU can configure the RLC to use the corresponding function according to the value of the IE.

eNB Window Size IE for PDCP

As shown in Table 15 A, the eNB utilizes a PDCP Window Size IE to indicate to the WTRU the size of the eNB's PDCP Window (e.g. for transmit and/or receive windows) that relates to this WTRU, in any appropriate unit such as bytes or number of packets (e.g. SDUs or PDUs).

TABLE 15 A

| Name | Semantics description |
|---|---|
| eNB Window Size | Indicates the size of the eNB window |

Upon reception, if eNB Window Size IE is included (e.g. in an RRC message), the WTRU configures PDCP to use the corresponding function according to the value of the IE. The WTRU can use the eNB's window size information to manage/limit the amount of data it sends to the eNB (e.g. via implementing a window mechanism such as a byte-based windowing mechanism for example), or for any other function.

PDCP Status Report Info IEs

The following IEs can be applied on a per-Radio Bearer basis.

Send Status Report IE

A PDCP Send Status Report IE is supported in this embodiment. As shown in Table 16, the eNB will utilize such an IE to indicate to the WTRU that the WTRU shall a send a PDCP Status Report at any one or more of the following pre-defined events: handover, RLC reset, PDCP reset, radio link failure, and MAC reset.

TABLE 16

| | Type/ | |
|---|---|---|
| Name | reference | Semantics description |
| Send Status Report | Enumerated | TRUE indicates that PDCP shall |
| | (Tru/false) | generate a Status Report (e.g., at |
| | | certain events such as handover) |

Upon reception, if the PDCP Send Status Report IE is included (e.g. in an RRC message), the WTRU configures PDCP to use the corresponding function according to the value of the IE.

Send Status Report at a Certain Event IE

As an alternative, multiple IEs corresponding to some different events at which the WTRU shall send a PDCP Status Report, as shown in Table 17 below.

TABLE 17

| | Type/ | |
|---|---|---|
| Name | reference | Semantics description |
| Send Status Report at | Enumerated | TRUE indicates that PDCP shall |
| event X | (Tru/false) | generate a Status Report when |
| | | event X occurs |
| Send Status Report at | Enumerated | TRUE indicates that PDCP shall |
| event Y | (Tru/false) | generate a Status Report when |
| | | event Y occurs |

The events X or Y could be particular events such as a handover event, an RLC reset event, reception of handover command event, a PDCP reset event, or a MAC reset event, or a radio link failure event. Upon reception, if IE Send Status Report at event X or Y is included (e.g. in an RRC message), the WTRU configures PDCP to use the corresponding function according to the value of the IE. Alternatively, one IE is defined to configure the Send status report IE, and another IE to specify the allowed triggering conditions.

Status Report Number of Transmissions (or Retransmissions) IE

In this embodiment shown in Table 18 below, a PDCP Status Report Number of Transmissions (or Retransmissions) IE is supported. The eNB utilizes such an IE to indicate to the WTRU that the WTRU can transmit (or retransmit) the PDCP Status Report a certain number of times.

TABLE 18

| Name | Semantics description |
|---|---|
| Number of transmissions | Indicates the number of |
| (or retransmissions) | transmissions or retransmissions |
| | for a PDCP status report. |

Upon reception, if Number of transmissions (or retransmissions) IE is included (e.g. in an RRC message), the WTRU configures PDCP to use the corresponding function according to the value of the IE.

Await Status Report IE

A PDCP Await Status Report IE is shown in Table 19. The eNB utilizes such an IE to indicate to the WTRU to await the reception of PDCP Status Report (in downlink) before it proceeds to transmit in the (target) cell, e.g. at handover, or at other events such as those that have been mentioned in prior sub-sections.

TABLE 19

| | Type/ | |
|---|---|---|
| Name | reference | Semantics description |
| Await Status Report | Enumerated | TRUE indicates that PDCP |
| | (Tru/false) | should wait to receive a |
| | | Status Report before starting |
| | | uplink transmission. |

Upon reception, if Await Status Report IE is included (e.g. in an RRC message), the WTRU configures PDCP to use the corresponding function according to the value of the IE. Other potential names or alternatives IEs are illustrated in Table 20 and include DL Status Report IE, which indicates that the eNB intends to send a downlink status report, e.g. at handover, or at other events such as those that have been mentioned in prior sub-sections. Hence, the WTRU should or could utilize the information in the downlink status report to optimize its transmissions, e.g. upon handover.

TABLE 20

| | Type/ | |
|---|---|---|
| Name | reference | Semantics description |
| Downlink Status Report | Enumerated | TRUE indicates that PDCP of |
| | (Tru/false) | the eNB will send a Status |
| | | Report to the WTRU, e.g. at |
| | | handover. FALSE indicates it |
| | | will not. |

Upon reception, if DL Status Report IE is included (e.g. in an RRC message), the WTRU configures PDCP to use the corresponding function according to the value of the IE.

Status Report Prohibit Timer IE

The eNB utilizes PDCP Status Prohibit IE to indicate to the WTRU that the WTRU shall prohibit the sending of a PDCP Status Report for a specified time (Timer Status Prohibit) following the sending of the previous PDCP Status Report.

TABLE 21

| | Type/ | |
|---|---|---|
| Name | reference | Semantics description |
| Timer Status Prohibit | Enumerated | TRUE indicates that PDCP shall |
| | (Tru/false) | generate a Status Report (e.g., at |
| | | certain events such as handover) |

As shown in Table 21 above, upon reception, if the Timer Status Prohibit IE is included (e.g. in an RRC message), the WTRU configures PDCP to use the corresponding function according to the value of the IE.

Allow Status Report Retransmission IE

The eNB utilizes a PDCP Allow Status Report Retransmission IE to indicate to the WTRU that the WTRU PDCP sub-layer can retransmit a status report based on HARQ delivery failure indication from the underlying sub-layers (e.g. MAC/HARQ)

TABLE 22

| | Type/ | |
|---|---|---|
| Name | reference | Semantics description |
| Allow Status Report | Enumerated | TRUE indicates that PDCP entity |
| Retransmission | (Tru/false) | can retransmit a status report |
| | | based on an indication from lower |
| | | sub-layers. |

As shown in Table 22 above, upon reception, if the Allow Status Report Retransmission IE is included (e.g. in an RRC message), the WTRU configures PDCP to use the corresponding function according to the value of the IE.

PDCP Status Report Info IE

Some or all of the above IEs that relate to PDCP Status Reports may be amalgamated as part of another IE (i.e. can constitute another IE), such as a PDCP Status Info IE as Table 23 shows below.

TABLE 23
Name

```
  Status Info
    Send Status Report
    Number of
transmissions (or
retransmissions)
    Downlink Status
Report
    Timer Status Prohibit
    Allow Status Report
Retransmission
```

Note that not all of the IEs in the table above need to be present in the above aggregated Status Info IE. Upon reception, if Status Info IE is included (e.g. in an RRC message), the WTRU configures PDCP to use the corresponding function according to the value of the IE. The Status Info IE may be part of another IE such as the PDCP configuration IE for DRBs.

PDCP Discard Info IEs

The following IEs can be applied on a per-Radio Bearer basis.

SDU Discard Mode IE

The eNB will utilize a PDCP SDU Discard Mode IE to indicate to the WTRU which mode the WTRU shall use to discard PDCP SDUs. Some possible options include: “Timer-based without explicit signaling”, “Timer-based with explicit signaling”, and “No discard”, or more generally “Timer-based” and “No discard”. Note that in explicit signaling, a signaling procedure (e.g. MRW) is used to notify the peer PDCP entity of the discarded SDU(s).

As shown in Table 24 above, upon reception, if SDU Discard Mode IE is included (e.g. in an RRC message), the WTRU configures PDCP to use the corresponding function according to the value of the IE. If the SDU Discard Mode IE is absent, then the WTRU does not configure PDCP discard.

TABLE 24

| Name | Semantics description |
|---|---|
| SDU Discard Mode | Indicates the discard mode that the WTRU PDCP |
| | entity should use to discard the PDCP SDUs from |
| | its transmitting buffer. Some options include: |
| | “Timer-based” and “No Discard”. Furthermore, it |
| | may possible to have “Timer-based without |
| | explicit signaling” and “Timer-based with explicit |
| | signaling” |

SDU Discard Timer IE

The eNB utilizes a PDCP SDU Discard Timer IE to indicate to the WTRU the timer value the WTRU shall use to discard PDCP SDUs, if timer-based discard is configured.

TABLE 25

| Name | Semantics description |
|---|---|
| SDU Discard Timer | Indicates the timer value for |
| | PDCP timer-based SDU |
| | discard. |

As shown in Table 25 above, upon reception, if SDU Discard Timer IE is included (e.g. in an RRC message), the WTRU configures PDCP to use the corresponding function according to the value of the IE.

Notify Discard to RLC IE

The eNB utilizes PDCP Notify Discard to RLC IE to indicate to the WTRU that the WTRU shall notify lower layer(s) (e.g. RLC) of its decision to discard a packet (e.g. SDU) (along with some identity of the discarded SDU).

TABLE 26

| Name | Semantics description |
|---|---|
| Notify Discard to RLC | Indicates the WTRU PDCP entity |
| | should notify the RLC entity of an |
| | SDU/PDU that was discarded in |
| | PDCP. |

As shown in Table 26 above, upon reception, if Notify Discard to RLC IE is included (e.g. in an RRC message), the WTRU configures PDCP to use the corresponding function according to the value of the IE.

SDU Discard Prohibit IE

The eNB utilizes a PDCP SDU Discard Prohibit IE to indicate to the WTRU the timer or counter value the WTRU shall use to limit how many SDUs get discarded when the discard timer expires. For example, this IE can specify that only X packets (e.g. 1 or 2 or . . . ) should get discarded upon timer expiry. Also, this IE (or another IE) can specify a minimum time between subsequent packet discards.

Note that this IE may not be needed especially if the timer-based discard function is supposed to discard every packet whose transmission has been delayed by more than a certain time.

TABLE 27

| Name | Semantics description |
|---|---|
| SDU Discard Prohibit | Indicates the counter (or |
| | timer) value that determines |
| | how many SDU(s) get |
| | discarded upon for PDCP |
| | discard timer expiry. |

As shown in Table 27 above, upon reception, if SDU Discard Prohibit IE is included (e.g. in an RRC message), the WTRU configures PDCP to use the corresponding function according to the value of the IE.

PDCP SDU Discard Info IE

Some or all of the above IEs that relate to PDCP Discard may be amalgamated as part of another IE (i.e. can constitute another IE), such as a PDCP SDU Discard Info IE Table 28 shows below.

TABLE 28
Name

```
  SDU Discard Info
    SDU Discard Mode
    SDU Discard Timer
    Notify Discard to
RLC
    SDU Discard Prohibit
```

Note that not all of the IEs in the table above need to be present in the above aggregated SDU Discard Info IE. Upon reception, if SDU Discard Info IE is included (e.g. in an RRC message), the WTRU configures PDCP to use the corresponding function according to the value of the IE. If the SDU Discard Info IE is absent, then the WTRU does not configure PDCP discard. The SDU Discard Info IE may be part of another IE such as the PDCP configuration IE for DRBs.

Ciphering and Integrity Check IEs

It may be possible for the E-UTRAN to reconfigure the algorithms being used for ciphering and/or integrity protection (e.g. during Handover or in Connected Mode). The concerned RRC message will, by means of an appropriate format, indicate which ciphering algorithm is to be used for C-plane traffic (i.e. signaling radio bearers) and which ciphering algorithm is to be used for U-plane traffic (other radio bearers). It may be necessary for the E-UTRAN (WTRU) to indicate to the WTRU (UTRAN) the PDCP SN at which the new configurations are activated. The following IEs may be: carried in any RRC message (UL or DL); included as part of a larger IE; and/or applied on a per-radio bearer basis. The RRC layer on receiving these values will pass this to the PDCP which will apply the changes at the indicated time/SN.

RB Activation Time Info

This IE indicates the PDCP SNs when the new security configurations will be activated. As shown in Table 29, if this IE is included in a message from the E-UTRAN this will apply for DL radio bearers. If this IE is included in a message from the WTRU this will apply for UL radio bearers.

TABLE 29

| Name | Type/reference | Semantics description |
|---|---|---|
| Radio Bearer Activation | | |
| Time | | |
| Radio Bearer ID | Radio Bearer | |
| | Identity | |
| PDCP Sequence | Integer (0 to 4095 | PDCP SN. Used for radio |
| Number | or 0 to 127 or 0 to | bearers mapped on RLC |
| | 31) | AM or UM or TM |

This IE may be defined for configuring multiple radio bearers at the same time.

Activation Time

As shown in table 30, this IE indicates the frame number/time at which the operations/changes caused by the related message (in this case security reconfiguration) shall take effect.

TABLE 30

| | Type/ | |
|---|---|---|
| Name | reference | Semantics description |
| Activation Time | Integer | CFN. Used for radio bearers |
| | | mapped on RLC-TM or UM or |
| | | AM |

### Other PDCP IEs

The following IEs can be applied on a per-Radio Bearer basis.

Lossless RB IE

In this embodiment shown in Table 31, the eNB utilizes a PDCP Lossless IE to indicate to the WTRU that this RB is lossless, which could imply other attributes such as that inter-eNB data forwarding is performed for this and that in-sequence delivery is required by the WTRU PDCP for such lossless RB.

TABLE 31

| Name | Type/reference | Semantics description |
|---|---|---|
| Lossless | Enumerated (Tru/ | TRUE indicates that this is a |
| | false) | lossless RB, and hence |
| | | WTRU PDCP shall perform |
| | | the functions required to |
| | | support lossless behavior. |

Upon reception, if Lossless RB IE is included (e.g. in an RRC message), the WTRU configures PDCP to use the corresponding function according to the value of the IE.

In Sequence Delivery IE

The eNB utilizes a PDCP In sequence delivery IE to indicate to the WTRU that the WTRU PDCP entity is required to provide in-sequence delivery (i.e. reordering) for this RB.

TABLE 32

| | Type/ | |
|---|---|---|
| Name | reference | Semantics description |
| In sequence delivery | Enumerated | TRUE indicates that WTRU |
| | (Tru/false) | PDCP shall provide/perform in- |
| | | sequence delivery of PDCP |
| | | SDUs to upper layers |

As shown in Table 32, upon reception, if In sequence delivery IE is included (e.g. in an RRC message), the WTRU configures PDCP to use the corresponding function according to the value of the IE.

Reordering Stop Mode IE

The eNB uses a PDCP Reordering Stop Mode IE to indicate to the WTRU that the WTRU PDCP entity whether it should use the timer mechanism (e.g. Flush Timer) to stop reordering following handover, or whether it should use stop reordering after all stored PDCP SDUs have been delivered to upper layers.

TABLE 33

| Name | Semantics description |
|---|---|
| Reordering Stop Mode | Indicates the mode that the |
| | WTRU should use to perform |
| | reordering: “Flush Timer”, |
| | “Delivery of stored PDCP |
| | SDUs”, or “Both”. |

As shown in Table 33 above, upon reception, if Reordering Stop Mode IE is included (e.g. in an RRC message), the WTRU configures the PDCP to use the corresponding function according to the value of the IE.

Flush Timer IE

The eNB uses a PDCP Flush Timer IE to indicate to the WTRU the value of the flush timer that the WTRU should use to stop reordering for this RB.

TABLE 34

| Name | Semantics description |
|---|---|
| Flush Timer | Indicates the value of the |
| | flush timer used to stop |
| | reordering |

As shown in Table 34, upon reception, if Flush Timer IE is included (e.g. in an RRC message), the WTRU configures the PDCP to use the corresponding function according to the value of the IE.

Allow Polling Via RLC IE

The eNB uses a PDCP Allow Via RLC IE to indicate to the WTRU that the WTRU PDCP entity may request/indicate to the underlying RLC entity to set the RLC polling bit (or polling mechanism in general), e.g. when certain packet are sent by PDCP, for this RB.

As shown in table 35, upon reception, if Allow Polling via RLC IE is included (e.g. in an RRC message), the WTRU configures the PDCP to use the corresponding function according to the value of the IE.

TABLE 35

| Name | Type/reference | Semantics description |
|---|---|---|
| Allow Polling via RLC | Enumerated | TRUE indicates that |
| | (Tru/false) | WTRU PDCP may |
| | | request/trigger the RLC |
| | | polling mechanism |

Allow Polling Via PDCP IE

The PDCP is to have its own polling mechanism that can be used to trigger the generation of a PDCP Status Report by the peer PDCP entity. A PDCP Allow Via PDCP IE is utilized by the eNB to indicate to the WTRU that the WTRU PDCP entity may utilize the PDCP polling mechanism, for this RB.

TABLE 36

| | Type/ | |
|---|---|---|
| Name | reference | Semantics description |
| Allow Polling via PDCP | Enumerated | TRUE indicates that WTRU |
| | (Tru/false) | PDCP may utilize the RLC |
| | | polling mechanism |

As shown in Table 36, upon reception, if Allow Polling via PDCP IE is included (e.g. in an RRC message), the WTRU configures PDCP to use the corresponding function according to the value of the IE.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for radio resource control (RRC) configuration of at least one of a radio link control (RLC) sublayer and packet data convergence protocol (PDCP) sublayer, the method comprising:
receiving an RRC message including information elements (IEs), wherein the IEs include a sequence number (SN) Length IE indicating SN size;
extracting the IEs from the RRC message; and
configuring functions and parameters of the RLC sublayer based on the extracted IEs, wherein the configuring functions and parameters includes configuring the RLC sublayer to use SNs according to the SN Length IE.

2. The method as in claim 1 wherein the SN Length IE is included an uplink IE to indicate the size of uplink SNs.

3. The method as in claim 1 wherein the SN Length IE is included in a downlink IE to indicate the size of downlink SNs.

4. The method as in claim 1 wherein the SN Length IE indicates a SN size of one of 5-bit or 10-bit.

5. The method as in claim 1 wherein the SN Length IE in an uplink IE is different from the SN Length IE in a downlink IE.

6. A method for radio resource control (RRC) configuration of at least one of a radio link control (RLC) sublayer and packet data convergence protocol (PDCP) sublayer, the method comprising:
receiving an RRC message including information elements (IEs), wherein the IEs include a Send Status Report IE;
extracting the IEs from the RRC message; and
configuring functions and parameters of the PDCP sublayer based on the extracted IEs, wherein the configuring functions and parameters includes configuring the PDCP sublayer to send a status report at one or more predefined events based on the Send Status Report IE.

7. The method as in claim 6, wherein the predefined events include: a handover, an RLC reset, a PDCP reset, a radio link failure and a MAC reset.

8. The method as in claim 6 wherein the IEs further include a PDCP Sequence Number (SN) Length IE indicating a SN size wherein:
the configuring functions and parameters includes configuring the PDCP sublayer to use SNs according to the PDCP SN length IE.

9. The method as in claim 6 wherein the IEs further include a service data unit (SDU) Discard Timer IE indicating a timer value for discarding PDCP SDUs wherein:
the configuring functions and parameters includes configuring the PDCP sublayer to discard PDCP SDUs based on the SDU Discard Timer.

10. The method as in claim 6 wherein the IEs further include a Flush Timer IE indicating a value of a flush timer to stop reordering after handover wherein:
the configuring functions and parameters includes configuring the PDCP sublayer to operate the flush timer according to the Flush Timer IE.

11. A wireless transmit/receive unit (WTRU) configured to perform radio resource control (RRC) configuration of at least one of a radio link control (RLC) sublayer and packet data convergence protocol (PDCP) sublayer, the WTRU comprising:
a receiver configured to receive an RRC message including information elements (IEs), wherein the IEs include a Sequence Number (SN) Length IE indicating SN size;
a processor configured to extract the IEs from the RRC message; and
the processor configured to configure functions and parameters of the RLC sublayer based on the extracted IEs, wherein the processor is configured to configure the RLC sublayer to use SNs according to the SN Length IE.

12. The WTRU as in claim 11 wherein the SN Length IE is included an uplink IE to indicate the size of uplink SNs.

13. The WTRU as in claim 11 wherein the SN Length IE is included in a downlink IE to indicate the size of a downlink SNs.

14. The WTRU as in claim 11 wherein the SN Length IE indicates a SN size of one of 5-bit or 10-bit.

15. The WTRU as in claim 11 wherein the SN Length IE in an uplink IE is different from the SN Length IE in a downlink IE.

16. The WTRU as in claim 11 configured as a user equipment (UE).

17. The WTRU as in claim 11 configured as an evolved Node B (eNB).

18. A wireless transmit/receive unit (WTRU) configured to perform radio resource control (RRC) configuration of at least one of a radio link control (RLC) sublayer and packet data convergence protocol (PDCP) sublayer, the WTRU comprising:
a receiver configured to receive an RRC message including information elements (IEs), wherein the IEs include a Send Status Report IE;
a processor configured to extract the IEs from the RRC message; and
the processor configured to configure functions and parameters of the PDCP sublayer based on the extracted IEs, wherein the processor is configured to configure the PDCP sublayer to send a status report at one or more predefined events based on the Send Status Report IE.

19. The WTRU as in claim 18 wherein the predefined events include: a handover, an RLC reset, a PDCP reset, a radio link failure and a MAC reset.

20. The WTRU as in claim 18 wherein the IEs further include a PDCP Sequence Number (SN) Length IE indicating a SN size wherein:
the processor is configured to configure the PDCP sublayer to use SNs according to the PDCP SN length IE.

21. The WTRU as in claim 18 wherein the IEs further include a service data unit (SDU) Discard Timer IE indicating a timer value for discarding PDCP SDUs wherein:
the processor is configured to configure the PDCP sublayer to discard PDCP SDUs based on the SDU Discard Timer.

22. The WTRU as in claim 18 wherein the IEs further include a Flush Timer IE indicating a value of a flush timer to stop reordering after handover wherein:
the processor is configured to configure the PDCP sublayer to operate the flush timer according to the Flush Timer IE.

23. The WTRU as in claim 18 configured as a user equipment (UE).

24. The WTRU as in claim 18 configured as an evolved Node B (eNB).
